(19) United States
(12) Patent Application Publication
(10) Pub. No.: US 2012/0194133 A1
(43) Pub. Date: Aug. 2, 2012

(54) ACTIVE CELL BALANCING USING INDEPENDENT ENERGY TRANSFER BUS FOR BATTERIES OR OTHER POWER SUPPLIES

(75) Inventors: Joshua Posamentier, Oakland, CA (US); James R. Burnham, Sunnyvale, CA (US); Kenneth R. Saller, Fort Collins, CO (US)

(73) Assignee: NATIONAL SEMICONDUCTOR CORPORATION, Santa Clara, CA (US)

(21) Appl. No.: 13/017,312

(22) Filed: Jan. 31, 2011

(51) Int. Cl. H02J 7/04

(52) U.S. Cl. 320/116

(57) ABSTRACT

A system includes a power source having multiple energy storage power cells. The system also includes multiple cell active balancing circuits. Each active balancing circuit is coupled across and associated with at least one of the power cells. Each active balancing circuit is also configured to provide energy to and draw energy from the at least one associated power cell. The system further includes an energy transfer bus configured to transfer energy between the active balancing circuits. In addition, the system includes a controller configured to control the transfer of energy between the active balancing circuits in order to control balancing of charges on the power cells. Each active balancing circuit could include a bi-directional direct current-to-direct current converter configured to convert and transfer DC energy between the associated power cell(s) and the energy transfer bus. The power source could include a battery, and the power cells could include battery cells within the battery.

### TECHNICAL FIELD

This disclosure is generally directed to power supply charging and discharging systems. More specifically, this disclosure is directed to active cell balancing (also known as cell equalization) using an independent energy transfer bus for batteries or other power supplies.

### BACKGROUND

Modern batteries, such as large lithium ion batteries, often include multiple battery cells. Unfortunately, the actual state of charge, and hence the output voltage, provided by each individual battery cell in a battery may vary slightly. For example, consider battery cells connected in series, where each battery cell is ideally designed to provide an output voltage of 4.1V at 100% state-of-charge (SOC). One of the battery cells could actually have an output voltage of 4.2V. Certain battery chemistries, including most lithium chemistry batteries, may be damaged or destroyed by under-voltage or over-voltage conditions. A mismatch in battery cells' SOC or open circuit voltage (OCV) also causes problems both during charge and discharge cycles.

A conventional dissipative or passive cell balancing system typically includes resistors that dissipate electrical energy from battery cells having higher SOCs. In the example above, the dissipation of electrical energy might cause the 4.2V output voltage to drop to the desired level of 4.1V. However, since electrical energy is dissipated using the resistors, this can result in significant energy being lost from the battery cells. Moreover, the dissipation generates heat, which reduces reliability and Coulombic efficiency during charge cycles. Additionally, passive balancing is only practical during charge cycles. Balancing with a passive system is not effective or useful during discharge or static conditions.

Not only that, battery chemistries are often very different, balancing currents required for battery cells often vary from battery to battery (even between those with the same chemistry), and battery pack configurations are often different. This makes voltage balancing of multiple battery cells even more difficult.

### BRIEF DESCRIPTION OF DRAWINGS

For a more complete understanding of this disclosure and its features, reference is now made to the following description, taken in conjunction with the accompanying drawings, in which:

FIG. 1 illustrates an example active cell balancing system using an independent energy transfer bus and reduced cell granularity in accordance with this disclosure;

FIG. 2 illustrates an example active cell balancing circuit supporting the use of an independent energy transfer bus and reduced cell granularity in accordance with this disclosure; and

FIG. 3 illustrates an example method for active cell balancing using an independent energy transfer bus and reduced cell granularity according to this disclosure.

### DETAILED DESCRIPTION

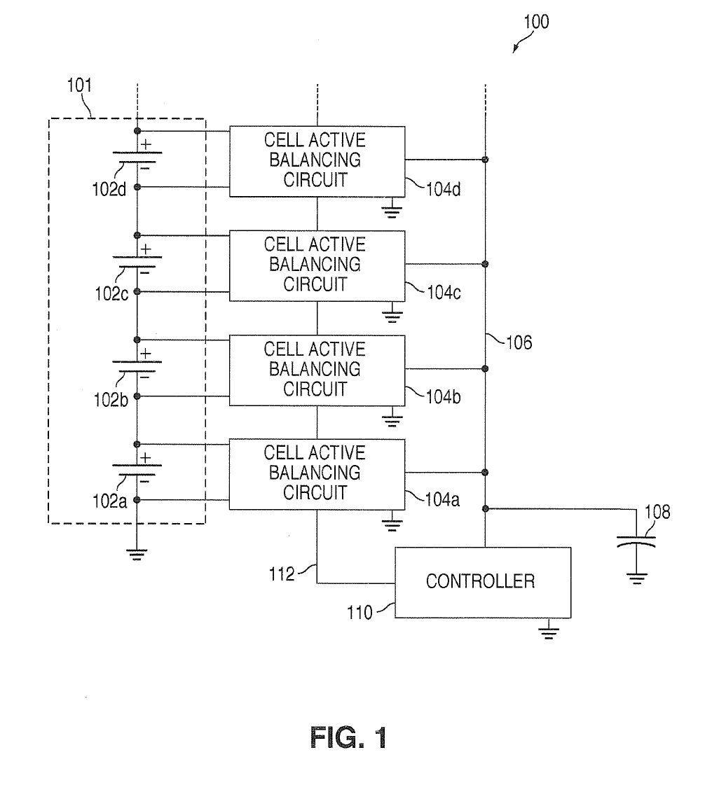

FIG. 1 through 3, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

FIG. 1 illustrates an example active cell balancing system 100 using an independent energy transfer bus and reduced cell granularity in accordance with this disclosure. As shown in FIG. 1, the system 100 includes or is coupled to a power source 101 having multiple power cells 102a-102d connected in series. The power cells 102a-102d represent any suitable sources of power within a module, such as battery cells within a battery. Each power cell 102a-102d could be designed to provide a specified amount of power, such as when each power cell 102a-102d is designed to provide a specific voltage. In particular embodiments, the power cells 102a-102d represent cells in a multi-cell lithium ion battery. The power cells 102a-102d are typically located within a common enclosure of the power source 101.

Each of the power cells 102a-102d is coupled to one of multiple cell active balancing circuits 104a-104d. The active balancing circuits 104a-104d operate in conjunction with an energy transfer bus 106 to transfer energy between power cells 102a-102d. For example, one or more active balancing circuits 104a-104d can drain excess energy from one or more of the power cells 102a-102d. At least some of the drained energy could then be provided to one or more other power cells 102a-102d via one or more other active balancing circuits 104a-104d. In this way, energy could be transferred bi-directionally from power cells having more energy to power cells having less energy. This can help to balance the states-of-charge (SOCs) for the power cells 102a-102d while reducing or minimizing energy dissipation.

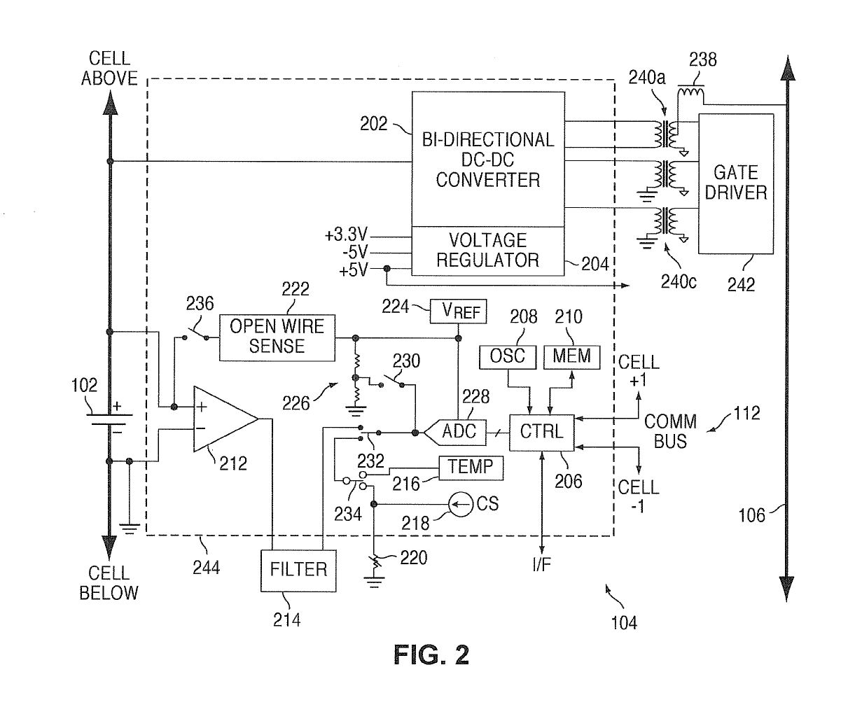

Each of the active balancing circuits 104a-104d includes any suitable structure for supporting bi-directional (and optionally isolated) transfer of energy to and from at least one power cell. For example, each of the active balancing circuits 104a-104d could include an isolated bi-directional direct current-to-direct current (DC-to-DC) converter coupled to a DC energy transfer bus. An example embodiment of the active balancing circuits 104a-104d is shown in FIG. 2, which is described below.

The energy transfer bus 106 supports the transport of energy between power cells 102a-102d via the active balancing circuits 104a-104d. The energy transfer bus 106 could transport any suitable energy, such as a DC balancing current, between the active balancing circuits 104a-104d. The energy transfer bus 106 includes any suitable conductive structure for transporting energy. Additionally, the energy transfer bus 106 may be stabilized by a voltage source from a controller 110. This may be converted via a DC-to-DC converter sourced from the top of the power source 101.

A capacitor 108 is coupled to the energy transfer bus 106. The capacitor 108 can store energy received over and release energy to the energy transfer bus 106. The capacitor 108 can, for example, be used to temporarily store energy being transferred between power cells 102a-102d. The capacitor 108 includes any suitable capacitive structure having any suitable capacitance.

A central controller 110 can control the overall operation of the active balancing circuits 104a-104d. For example, the controller 110 could receive voltage and temperature measurements from the active balancing circuits 104a-104d and identify how energy should be transferred between the power cells 102a-102d. As a particular example, the controller 110 could use the voltage measurements to identify the power cell(s) with the highest voltage(s) and the power cell(s) with the lowest voltage(s). The controller 110 could then cause the active balancing circuits 104a-104d to transfer energy from the power cell(s) with the highest voltage(s) to the power cell(s) with the lowest voltage(s). The controller 110 could perform any other suitable actions to control the active balancing functions or other operational aspects of the system 100. The controller 110 includes any suitable structure for controlling at least the active balancing between power cells in a system. The algorithms of the controller 110 may be based on SOC estimation for the cells 102a-102d under management or various other variables.

The controller 110 can communicate with the active balancing circuits 104a-104d using a communication bus 112. The communication bus 112 can transport any suitable data. For example, each of the active balancing circuits 104a-104d could measure various characteristics of a power cell (such as output voltage, output current, or temperature) and provide that data to the controller 110 over the bus 112. The controller 110 could also provide control data for controlling the active balancing to the active balancing circuit 104a-104d over the bus 112. The communication bus 112 includes any suitable structure for transporting data between components and performing any related functions, such as shifting communications voltage and ground reference levels, providing galvanic isolation, and buffering.

As shown in FIG. 1, the system 100 provides power management using active cell balancing with reduced cell granularity. Each power cell 102a-102d can have its own associated active balancing circuit 104a-104d that can control the flow of energy into and out of that power cell. This yields a high performance, efficient balancing system that may easily be scaled to any suitable number of power cells and any suitable balancing current. This allows the balancing system to be used with batteries or other power supplies having cells with highly varying sizes and current requirements. This approach is much more flexible/granular and scalable to higher currents and numbers of power cells. It also mitigates issues around high-voltage stacks of battery cells or other power cells with the associated isolation requirements (such as 60V maximum in a stack of 12 cells). This allows the use of lower cost, lower voltage processes that support more integration, rather than having different chips requiring different processes.

Although FIG. 1 illustrates one example of an active cell balancing system 100 using an independent energy transfer bus and reduced cell granularity, various changes may be made to FIG. 1. For example, the system 100 could include any number of power cells, active balancing circuits, energy transfer buses, capacitors, controllers, and communication buses. Also, each power cell 102a-102d is shown to have an associated cell active balancing circuit 104a-104d, which provides active balancing with single-cell granularity. However, each active balancing circuit could be coupled across any proper subset of power cells in a power source 101. In addition, the functional division shown in FIG. 1 is for illustration only. Various components in FIG. 1 could be combined, further subdivided, or omitted and additional components could be added according to particular needs. As a specific example, an active balancing circuit could be embedded or otherwise incorporated into a battery cell or other power cell to provide a “smart” power cell with integrated balancing electronics.

FIG. 2 illustrates an example active cell balancing circuit 104 supporting the use of an independent energy transfer bus and reduced cell granularity in accordance with this disclosure. As shown in FIG. 2, the active balancing circuit 104 includes or is coupled to a power cell 102 and an energy transfer bus 106. The power cell 102 can be coupled in series to a power cell “below” the power cell 102 and to a power cell “above” the power cell 102. The power cell below the power cell 102 is “below” in the sense that its output voltage is lower than the output voltage of the power cell 102. Similarly, the power cell above the power cell 102 is “above” in the sense that its output voltage is higher than the output voltage of the power cell 102.

In this example, the active balancing circuit 104 includes a bi-directional DC-to-DC converter 202. The DC-to-DC converter 202 converts DC power from one form to another. For example, the DC-to-DC converter 202 could receive DC power at one voltage and current, and the DC-to-DC converter 202 could output DC power at a different voltage and current. The DC-to-DC converter 202 is bi-directional in that the converter 202 can receive DC power from the power cell 102 and provide that DC power to the energy transfer bus 106, or vice versa. Additionally, the DC-DC converter 202 may operate in either constant current or constant voltage mode. The DC-to-DC converter 202 includes any suitable structure for converting DC power. In some embodiments, the DC-to-DC converter 202 is galvanically isolated from the energy transfer bus 106, has a ratio range of 1:10 to 1:25, can handle currents of ±2 A, and has an efficiency over 85%.

The DC-to-DC converter 202 includes or is associated with a voltage regulator 204 that generates regulated voltages. The voltage regulator 204 could, for example, generate 3.3V and ±5V voltages for use by other components of the active balancing circuit 104 or by components outside of the active balancing circuit 104. The voltage regulator 204 includes any suitable structure for generating one or more regulated voltages.

The operation of the DC-to-DC converter 202 is controlled using a control unit 206. For example, the control unit 206 could receive measurement data or other data from various components of the active balancing circuit 104. The control unit 206 could also communicate via the communication bus 112 to send and receive data. Based on the data, the control unit 206 could modify the operation of the DC-to-DC converter 202 in order to facilitate energy transfers to support active cell balancing. Note that the specific operations performed by the control unit 206 could be controlled remotely (such as by the controller 110) or locally (such as by logic executed by the control unit 206). The control unit 206 includes any suitable structure for controlling operations of the active balancing circuit 104. For instance, the control unit 206 could include a microprocessor, microcontroller, digital signal processor, field programmable gate array, or application specific integrated circuit. In particular embodiments, the control unit 206 could implement a multipoint control unit (MCU) or a state machine.

The control unit 206 is coupled to an oscillator 208 and a memory 210. The oscillator 208 provides a clock signal to the control unit 206, and the memory 210 provides data storage and/or retrieval for the control unit 206. The memory 210 could, for instance, store instructions to be executed by the control unit 206. The oscillator 208 includes any suitable structure for providing a clock signal. The memory 210 includes any suitable storage and retrieval device(s), such as an electrically erasable programmable read only memory (EEPROM).

The active balancing circuit 104 also includes various components providing sensing functionality. For example, a differential amplifier 212 is coupled across the power cell 102. The differential amplifier 212 amplifies a voltage difference across the input and output of the power cell 102 and provides the amplified voltage to a filter 214. The differential amplifier 212 and filter 214 therefore generate a measure of the voltage provided by the power cell 102. The differential amplifier 212 includes any suitable structure for amplifying a voltage difference. The filter 214 includes any suitable filtering structure, such as a bandpass filter.

An “on-chip” temperature sensor 216 can measure the local temperature of the active balancing circuit 104. A current source 218 and a thermistor 220 could be used for external temperature measurements. For instance, the current source 218 could provide a known current, and the resistance of the thermistor 220 varies with temperature to generate a variable voltage that can be used to identify the temperature. The temperature sensor 216 includes any suitable structure for measuring temperature. The current source 218 includes any suitable source providing a current. The thermistor 220 includes any suitable structure with a resistance that varies based on temperature.

An open wire sense unit 222 and a precision reference voltage (v_{REF}) source 224 operate to measure output current from the power cell 102 and to detect an open wire condition (meaning the power cell 102 is no longer electrically connected to other cells). The open wire sense unit 222 includes any suitable structure for detecting an open circuit. The precision reference voltage source 224 includes any suitable structure for providing a precision reference voltage. A voltage divider 226 is used to generate a lower known voltage based on the precision reference voltage. This known voltage can be used to test operation of other components in the active balancing circuit 104. The voltage divider 226 includes any suitable structure for dividing a voltage.

An analog-to-digital converter (ADC) 228 digitizes various voltage values and provides the digital values to the control unit 206. The control unit 206 could use the digital values or output the digital values over the communication bus 112 to support active balancing control. The digital values output by the ADC 228 could include digitized versions of filtered voltage difference values output by the differential amplifier 212, temperature values output by the temperature sensor 216, voltages generated across the thermistor 220 by the current source 218, and a known voltage generated by the voltage divider 226. The ADC 228 includes any suitable structure for converting analog values into digital values, such as a 14-bit ADC.

Various switches 230-236 help to adjust the operation of the active balancing circuit 104. For example, the switches 230-236 effectively function as a multiplexer to control which analog signal is provided to the input of the ADC 228. Each of the switches 230-236 includes any suitable structure for selectively coupling components, such as a transistor. Also, each of the switches 230-236 can be controlled in any suitable manner, such as by being controlled by the control unit 206 or an external control unit (like the controller 110).

Various isolation transformers 238 and 240a-240c couple the energy transfer bus 106 and gate drivers 242 to the DC-to-DC converter 202. Each of the transformers 238 and 240a-240c helps to isolate electrical signals on one side of the transformer from electrical signals on the other side of the transformer. In this example, the transformers 238 and 240a help to couple the energy transfer bus 106 to the DC-to-DC converter 202. The transformers 240a-240c also couple the gate drivers 242 to the DC-to-DC converter 202. In this way, both power and control signals can be provided in an isolated manner to the DC-to-DC converter 202. Each of the transformers 238 and 240a-240c includes any suitable structure for transferring electrical energy in an isolated manner. Note, however, that isolation of the control signals may also be accomplished with other types of isolation technology, such as opto-isolation or capacitive isolation. The gate drivers 242 include any suitable structure for generating control signals for driving gates of transistors in the DC-to-DC converter 202.

In this example, the active balancing circuit 104 supports charging and discharging of the power cell 102 using the DC-to-DC converter 202. When the charging and discharging of multiple power cells 102 by multiple active balancing circuits 104 are coordinated, the active balancing circuits 104 provide active balancing with single-cell granularity, regardless of battery or other power cell chemistry, balancing currents, and power cell configuration. Moreover, the local energy transfer bus 106 can be used to easily route energy between the power cells. In addition, the active balancing circuit 104 provides local intelligence, sensing (such as voltage and temperature sensing), and control for the charge/discharge functionality.

In particular embodiments, most or all of the components of the active balancing circuit 104 in FIG. 2 could be integrated into a single package. In FIG. 2, for example, the items within the dashed line could be implemented within a single integrated circuit chip 244. The various other components of the active balancing circuit 104 in FIG. 2 could reside outside of the integrated circuit chip 244 due to size or other constraints, such as when components having large inductors or capacitors are coupled to pins of the integrated circuit chip 244. In this example, the control unit 206 could communicate via one or more interfaces (I/F) with external components. The control unit 206 could use any suitable interface(s), such as a General Purpose Input Output (GPIO) interface, a Serial Peripheral Interface (SPI), and/or a Joint Test Action Group (JTAG) debug interface. Note, however, that any other arrangement of components in the active balancing circuit 104 could be used.

Although FIG. 2 illustrates one example of an active cell balancing circuit 104 supporting the use of an independent energy transfer bus and reduced cell granularity, various changes may be made to FIG. 2. For example, the active balancing circuit 104 could include any other or additional sensing circuitry. Also, the active balancing circuit 104 could include other circuit components that perform the same or similar functions as those described above. In addition, as noted above, while single-cell granularity is shown here, the active cell balancing circuit 104 could be coupled across multiple power cells 102.

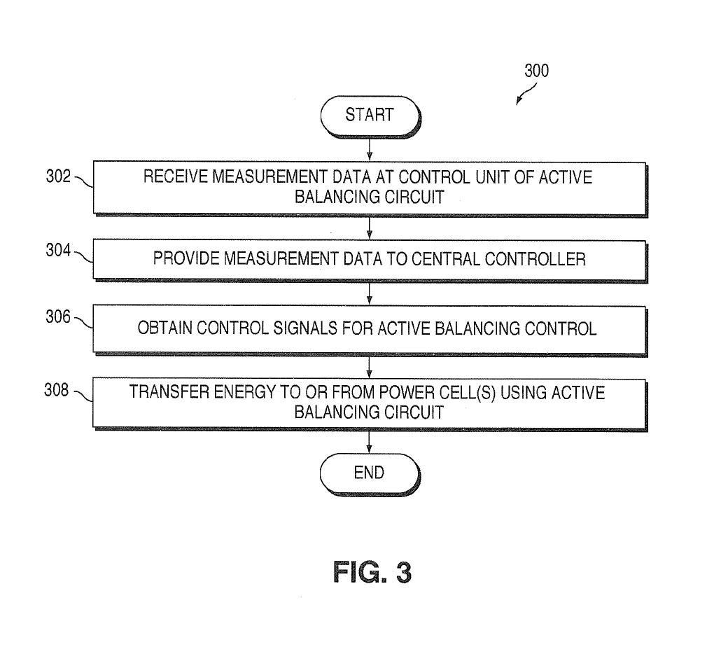

FIG. 3 illustrates an example method 300 for active cell balancing using an independent energy transfer bus and reduced cell granularity according to this disclosure. As shown in FIG. 3, measurement data is received at a control unit of an active balancing circuit at step 302. This could include, for example, the control unit 206 in the active balancing circuit 104 receiving data associated with the voltage and temperature of at least one battery cell or other power cell 102. The measurement data can optionally be provided to a central controller at step 304. This could include, for example, the control unit 206 in the active balancing circuit 104 transmitting the measurement data to the controller 110 via the communication bus 112.

Control signals for controlling the active balancing of a battery pack or other module containing multiple power cells are obtained at step 306. The control signals could be received from the controller 110 over the communication bus 112. The control signals could also be generated internally within the active balancing circuit 104 by the control unit 206, such as by using the measurement data. Based on the control signals, energy is then transferred to or from the power cell(s) using the active balancing circuit at step 308. This could include, for example, the DC-to-DC converter 202 transferring energy from the power cell(s) 102 to the energy transfer bus 106 or transferring energy from the energy transfer bus 106 to the power cell(s) 102.

Although FIG. 3 illustrates one example of a method 300 for active cell balancing using an independent energy transfer bus and reduced cell granularity, various changes may be made to FIG. 3. For example, various steps in FIG. 3 could overlap, occur in parallel, or occur multiple times.

It may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system comprising:
a power source comprising multiple energy storage power cells;
multiple active balancing circuits, each active balancing circuit coupled across and associated with at least one of the power cells, each active balancing circuit also configured to provide energy to and draw energy from the at least one associated power cell;
an energy transfer bus configured to transfer energy between the active balancing circuits; and
a controller configured to control the transfer of energy between the active balancing circuits in order to control balancing of charges on the power cells.

2. The system of claim 1, wherein each active balancing circuit comprises:
a bi-directional direct current-to-direct current (DC-to-DC) converter configured to convert and transfer DC energy between the at least one associated power cell and the energy transfer bus; and
a control unit configured to control the DC-to-DC converter.

3. The system of claim 2, wherein each active balancing circuit further comprises:
sensing circuitry configured to measure at least one of: an output voltage, an output current, and a temperature of the at least one associated power cell.

4. The system of claim 3, wherein the control unit is configured to at least one of:
communicate measurements from the sensing circuitry to the controller; and
use the measurements from the sensing circuitry to control the DC-to-DC converter.

5. The system of claim 3, wherein the sensing circuitry comprises:
a differential amplifier configured to amplify a voltage difference across the at least one associated power cell;
a filter configured to filter an output of the differential amplifier; and
a temperature sensor.

6. The system of claim 3, wherein each active balancing circuit further comprises:
an analog-to-digital converter configured to convert analog signals from the sensing circuitry into digital values for the control unit; and
switches forming a multiplexer that is configured to selectively provide different analog signals from the sensing circuitry to the analog-to-digital converter.

7. The system of claim 2, further comprising:
isolation transformers coupling the DC-to-DC converter to the energy transfer bus and to one or more gate drivers.

8. The system of claim 1, wherein:
the power source comprises a battery; and
the power cells comprise battery cells within the battery.

9. The system of claim 8, wherein each active balancing circuit is embedded within one of the battery cells.

10. The system of claim 1, further comprising:
a capacitor coupled to the energy transfer bus and configured to store energy received from the energy transfer bus.

11. An apparatus comprising:
an active balancing circuit configured to be coupled across a proper subset of energy storage power cells in a power source, the active balancing circuit configured to provide energy to and draw energy from the subset of power cells;
wherein the active balancing circuit comprises:
a bi-directional direct current-to-direct current (DC-to-DC) converter configured to convert and transfer DC energy between the subset of power cells and an energy transfer bus; and
a control unit configured to control the DC-to-DC converter.

12. The apparatus of claim 11, wherein the active balancing circuit further comprises:
sensing circuitry configured to measure at least one of: an output voltage, an output current, and a temperature of the subset of power cells.

13. The apparatus of claim 12, wherein the control unit is configured to at least one of:
communicate measurements from the sensing circuitry to an external controller; and
use the measurements from the sensing circuitry to control the DC-to-DC converter.

14. The apparatus of claim 12, wherein the sensing circuitry comprises:
a differential amplifier configured to amplify a voltage difference across the subset of power cells;
a filter configured to filter an output of the differential amplifier; and
a temperature sensor.

15. The apparatus of claim 12, wherein the active balancing circuit further comprises:
an analog-to-digital converter configured to convert analog signals from the sensing circuitry into digital values for the control unit; and
switches forming a multiplexer that is configured to selectively provide different analog signals from the sensing circuitry to the analog-to-digital converter.

16. The apparatus of claim 11, wherein the power cells comprise battery cells within a battery.

17. The apparatus of claim 16, wherein the active balancing circuit is embedded within one of the battery cells.

18. A method comprising:
obtaining measurements associated with multiple power cells within a power supply; and
transferring energy to and from proper subsets of the power cells within the power supply using active balancing circuits coupled across the proper subsets of power cells.

19. The method of claim 18, wherein transferring the energy comprises substantially balancing charges on the power cells.

20. The method of claim 18, wherein:
the power source comprises a battery;
the power cells comprise battery cells within the battery; and
each active balancing circuit is embedded within one of the battery cells.
